(19) United States
(12) Patent Application Publication
(10) Pub. No.: US 2012/0099604 A1
(43) Pub. Date: Apr. 26, 2012

(54) HOME NETWORK APPARATUS

(75) Inventor: David Cohen, Jerusalem (IL)

(73) Assignee: TANGOTEC LTD., Jerusalem (IL)

(21) Appl. No.: 13/379,050

(22) PCT Filed: Jun. 21, 2010
(86) PCT No.: PCT/IL10/00490

§ 371 Date: Dec. 19, 2011

(30) Foreign Application Priority Data
Jun. 22, 2009 (GB) 0910741.8

(51) Int. Cl. H04J 3/26

(52) U.S. Cl. 370/432

(57) ABSTRACT

The invention relates to a Residential Broadband Cable Communicator for communicating over two or more types of cables within a house, each type of cables defines a channel, comprising (a) a first port connected to a home Ethernet device, (b) plurality of second ports each of said second ports being connected respectively to one of said channels, (c) a HomePlug modem for receiving data from said Ethernet device through said first port, and transmitting the same simultaneously through two or more of said second ports over two or more of said channels respectively to another Residential Broadband Cable Communicator, and for receiving a selected best quality data signal from a selector, and conveying the same to said Ethernet device, (d) a selector

### FIELD OF THE INVENTION

The present invention relates to the field of local networks. More particularly, the invention relates to the transmission of information over various types of existing cables, forming an extended home network.

### BACKGROUND OF THE INVENTION

As the number of electronic communication devices in houses increases, there is a demand for a way to permit those devices to communicate between them and with external networks. Many houses are equipped with cables (or wires) of various types as a part of the house infrastructure. Typically, said various cables may include electricity cables, telephone cables, TV cables, data cables, etc.

Several communication standards have been developed to allow devices to communicate over said various types of cables, or wirelessly. However, the evolving standards, and the increased need for a higher data rate do not appear to enable efficient communication over all the various types of installed cables. As a result, the existing standards and devices require in many cases the addition of special wiring to the existing ones, or to use wireless links. The existing solutions support a relatively low bit rate, fail to provide a high QoS (Quality of Service), and IPTV and require in many cases the physical installation of additional wires in the house.

Home network technologies using coax cables are known. The Multimedia over Coax Alliance (MoCA™, see mocalliance.org), provides an example of a suitable specification (MoCA 1.0) for networking of digital video and entertainment using existing coaxial cable. Home networking over coax taps into the vast amounts of unused bandwidth available on the in-home coax.

More than 70% of homes in the United States have coax already installed into the home infrastructure. Home networking technology allows homeowners to utilize cables within the house infrastructure for networking, and to deliver other various types of entertainment data with high QoS (Quality of Service) and at high speed (270 Mbps).

However, unlike electrical outlets that typically exist in all the rooms of the house, most houses are equipped with coax cables and outlets for said cables only at specific locations of the house, such as family rooms, media rooms, or main bedrooms. Therefore, the existing coax cables can provide only a limited solution to the need for a high data rate communication between various devices (such as computers, TVs, game devices, etc.) within the house.

With the growth of the market and the need to distribute data, it become apparent that the limited coverage of wireless networks can not fully answer the need for distributing data at rates above 100 Mbps, such as required by various applications including for example video over IP. Even when providing a powerful wireless access point in one room of the house, other rooms may still suffer a bad coverage due to concrete walls and other interferences. Moreover, as the data rate increases, the area covered by the wireless network decreases, for example, the most up-to-date protocol of the wireless network, namely 802.11n, specifies a data rate of more than 100 Mbps at an open space up to 20 meters.

HomePlug technology utilizes the electrical wires of the house for communicating broadband Internet, HD video, digital music and smart energy applications between rooms of the house. Installing a network over the electrical wires is done by plugging in communication modems and connecting them to an Internet Service Provider (ISP). A typical installation starts with the connection of a communication modems to a router by an Ethernet cable, and then plugging the communication modems into the nearest power outlet. Adding other devices to the network simply requires the plugging in of a communication modem to an outlet near the device to be connected, and connecting that device to the adapter via an Ethernet cable. The power-line adapter can also be plugged into a hub or switch when multiple devices (computers, printers, IP phones, etc.) need to be connected in a single room.

Among other things, HomePlug technology allows the use of Ethernet in bus topology, which is very desirable in some circumstances. This is achieved by use of advanced Orthogonal Frequency-Division Multiplexing (OFDM) modulation that allows co-existence of several distinct data carriers in the same wire. The use of OFDM also allows the turning-off (masking) of one or more of the sub-carriers. However, HomePlug technology cannot propagate signals effectively across different electrical phases in the house. Generally, the transmission over the power-lines alone is considered unreliable, although it works better in newer houses, or over short distances.

Various solutions have been developed to the limited coverage problem. Corinex, (http://www.corinex.com/in-building-solution-2.html) provides a partial solution to said problem, by use of existing the electrical lines or coaxial cables as a backbone to achieve transmission speeds of up to 200 Mbps. However, the solution of Corinex fails to support or utilize all the available resources in the house (such as the telephone twisted pairs wires). In addition, when the communication device of Corinex is connected in parallel to both the coax and the electrical lines, the user has to select which network type to use (coaxial or power line) and this selection which is made by means of a manual switch remains at that selected state until the user changes the state of the switch, in which he replaces the selected network type (e.g., from the electrical lines to a coaxial line, or vice versa). However, it is well known that the quality of communication over wires may vary over time. Therefore, a prior determination in advance of the type of connection may not provide the highest possible throughput over time.

Another attempt to provide a reliable and high performance home network at unlimited coverage is offered by Elcon (http://www.elcon-system.de/index.php?id=1&L=2). Elcon's system provides triple play services (TV, Data, and Telephone) over an existing infrastructure of coaxial network or power lines. However, also Elcon, in similarity to Corinex, requires the user to determine the selected network type by means of a manual switch. Said switch has still another task. A major problem of prior art systems is the noise and mutual interferences between the various channels of the network. In order to prevent such noise and interferences, the prior art solutions employ said manual switch also for disconnecting the circuit which is currently unused. Thus, the solutions of Elcon and Corinex fail to provide a continuous transmission and parallel operation.

Even though the prior art systems establish a home network over one or more of different channels (i.e., different types of cables, such as electrical, coax, or twisted pairs), they do not verify and select the use of the best channel available at any given time. The average user does not have the knowledge, ability, and means for determining and selecting the best available channel (i.e., Coax, Power line, Twisted pair, Cat5, etc).

A need therefore exists in the art for a system that provides a reliable home network having essentially unlimited coverage, which incorporates the important benefits of prior art systems while addressing the drawback of the prior art systems as noted above.

It is therefore an object of the present invention to provide a plug-and-play system that can easily be installed in existing houses without need for new wiring.

It is another object of the present invention to provide a system which is adapted to transfer data over various types of wires and which can connect to any type of plug socket.

It is yet another object of the present invention to provide a system which enables a high speed data transfer rate up to 85-200 Mbps.

It is an additional object of the present invention to provide a system having a built-in QoS application, supporting smooth, leg-free streaming.

It is yet another object of the present invention to automatically transfer data over the best available home channel.

It is still another object of the present invention to provide a system adapted to maintain a continuous transmission even when the active channel fails.

The feature of verification and identification of the best available channel by the system of the invention is referred to hereinafter as automatic-sensing. The feature of selecting the best available channel for transmission without manual switching between channels is referred to hereinafter as automatic-selecting.

Other objects and advantages of the invention will become apparent as the description proceeds.

### SUMMARY OF THE INVENTION

The invention relates to a Residential Broadband Cable Communicator for communicating over two or more types of cables within a house, each type of cables defines a channel, comprising: (a) a first port connected to a home Ethernet device; (b) plurality of second ports each of said second ports being connected respectively to one of said channels; (c) a HomePlug modem for receiving data from said Ethernet device through said first port, and transmitting the same simultaneously through two or more of said second ports over two or more of said channels respectively to another Residential Broadband Cable Communicator, and for receiving a selected best quality data signal from a selector, and conveying the same to said Ethernet device; (d) a selector for: (i) receiving a combined signal, said combined signal combines two or more data signals that are received from two or more of said channels respectively through said second ports; (ii) checking said combined signal, determining a best quality data signal from said combined signal, selecting said best quality data signal, and conveying the same to said HomePlug modem.

Preferably, the best quality signal which is selected is the one having a highest amplitude.

Preferably, the Communicator further comprises a splitter-combiner member for splitting data received from said HomePlug modem to said two or more channels, and for combining two or more data signals received from said two or more channels thereby to form said combined signal.

Preferably, the combiner further comprises a set of filters for preventing interferences between channels, and for enabling all signals to run simultaneously on said two or more channels without collisions.

Preferably, the selector operates upon each signal received, and wherein the channel selection by the selector remains the same between any two selection steps.

Preferably, the Communicator further comprises transformers, for providing channels insulation and impedance matching.

Preferably, said two or more types of cables are selected from the group comprising power-line cables, coaxial cables, and phone-line cables.

In an embodiment of the invention, said Ethernet device is selected from a group consisting of ISP modem, Lap-top computer, PC, modem, IPTV, HDTV, and telephone.

Preferably, the selector selects a data signal from said combined signal by selecting one carrier from among plurality of carriers employing advanced OFDM on said combined signal.

Preferably, said selector performs the best quality signal selection while keeping the transmission continuous.

Preferably, the set of filters comprises a first High Pass Filter (HPF) for preventing interferences between said HomePlug modem to a phone channel, and between said power-line channel and the coax channel, and a second Low Pass Filter (LPF) for preventing interferences between said power-line channel and said coax channel.

Preferably, said data signal is transferred over said power-line channel even in the absence of power in the power-line.

Preferably, the data transmission is performed at low frequency, namely, 5-30 MHz.

### BRIEF DESCRIPTION OF THE DRAWINGS

In the drawings:

FIG. 1 illustrates one exemplary home network embodiment employing the present invention;

FIG. 2 schematically illustrates a block diagram of a RBCC;

FIG. 3 illustrates a circuit diagram of one exemplary embodiment of a RBCC;

### DETAILED DESCRIPTION OF THE INVENTION

In the following description, for the purpose of illustration, numerous specific details are provided. As will be apparent to the skilled person, however, the invention is not limited to such specific details and the skilled person will be able to devise alternative arrangements.

As previously mentioned, high speed home network systems which utilize various cables of the house exist in the art. Such prior art systems comprise a Residential Broadband Cable Communicator (RBCC) which is connected on one hand to any type of home device (such as computer, TV, TV Cable Modem, IPTV, etc.) or an Internet Provider modem and on the other hand to one or more of plug sockets within the house. As previously mentioned, the prior art systems suffer from several drawbacks, such as: (a) they apply a “fixed” selection of the communication over only one type of home cable, and when this cable fails for some reason, the communication fails; (b) they cannot automatically determine and preferring the communication from one type of cable to another, when degradation in the communication quality occurs; and (c) they do not provide a continuous operation while switching between channels.

The setting up of such a home network is relatively easy, it requires only connecting a RBCC at each home device spot. Each RBCC is typically a plug-and-play device which is capable of connecting automatically to another (RBCC) for transfer of high speed data between them. For example, the data rate may reach 85-200 Mbps. The RBCC device may have an optional wireless/Wi-Fi interface for providing wireless coverage as well.

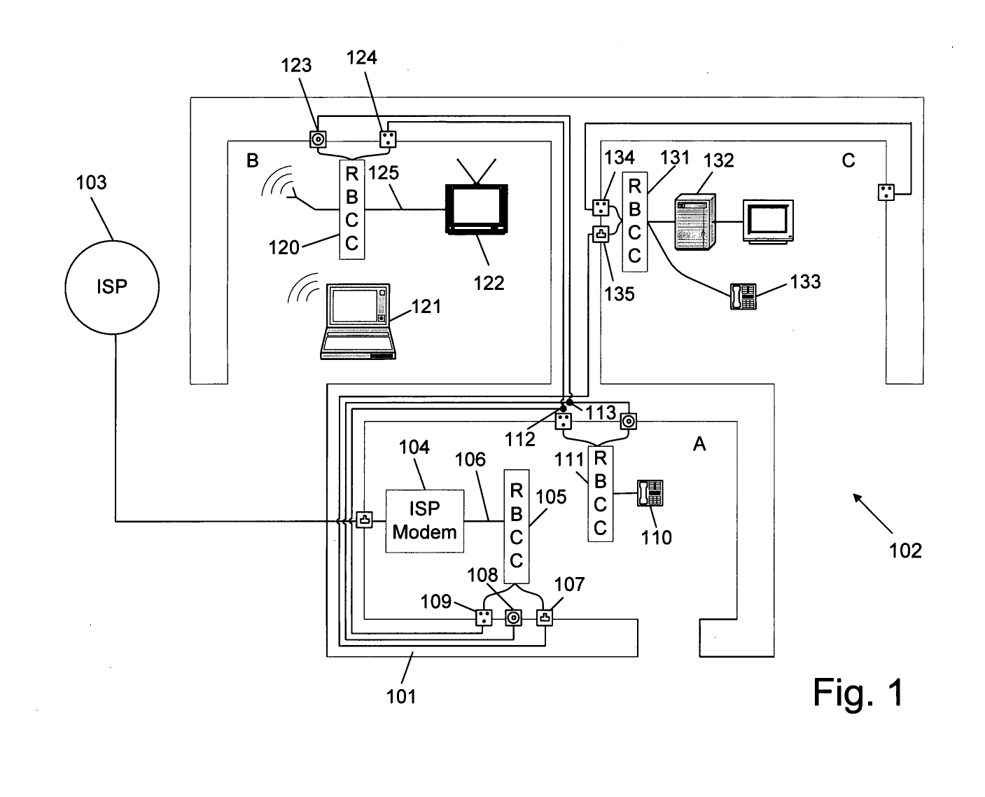

FIG. 1 illustrates an embodiment of a home network employing the present invention. In this embodiment the network coverage is extended using only existing infrastructure cables 101 of the house 102. An Internet Service Provider (ISP) 103 communicates with the house in a conventional manner using ISP modem 104 which is located at room A of the house. A RBCC 105 is connected at room A to the ISP modem 104 using, for example, a cable 106, or wirelessly (for example using a CAT-5 cable, USB cable, Wi-Fi, etc.). Other RBCCs are connected similarly to other home devices. For example, RBCC 131 is connected in room C to a phone device 133 and to Personal Computer (PC) 132. Still another RBCC 120 is connected wirelessly at room B to laptop computer 121, and to an IPTV (Internet Protocol TV) 122. Once a RBCC is connected to a home device and/or to an ISP modem, it may be connected to any one or more of plug sockets available at the respective location. A plug socket may lead, for example, to a phone line 107, coaxial cable 108, or power-line 109. In this embodiment, the RBCC 105 is connected at room A to sockets 107-109, therefore capable of communicating data to any phone, coaxial or power-line socket respectively available in the house. It can be seen that, for example, rooms A and B are equipped with different types of sockets.

In Room A, phone 110 is connected to a second RBCC 111, which is in turn also connected to the power-line socket and coax socket, therefore, data is communicated to phone 110 through the power-line 112 and coax cable 113. The RBCC 105, and RBCC 11, both located in room A, communicate over both the coax and power lines, however, RBCC 111 is adapted to automatically sense the channel providing the better quality and selects the data received through it. As a result, data is automatically received through the best available channel. In one embodiment the RBCC transmits data simultaneously at all the channels available, i.e., the power lines, the coax lines, and the phone lines. On the receiving side, the corresponding RBCC senses the three channels, determines the channel which provides a best quality signal, and selects receipt the data over said best channel, as determined.

It is well known that lines are subjected to noises and other interruptions. A significant advantage of the present invention resides in the capability of automatically sensing and selecting the channel which provides best quality of communication. Generally, all the channels that are available at each RBCC location, respectively, are used for communicating data. Therefore, even when a channel fails or becomes very noisy, the RBCC detects such degeneration of the channel, and switches to receive data from another channel. The RBCC continuously senses the amplitudes of all the signals received, and switches to receive data from the best quality channel which, provides the signal with the highest amplitude. In another embodiment, another criteria than a highest amplitude signal may be applied for selecting the best quality signal (and the corresponding channel). In still another embodiment, the determination of a best quality channel is made periodically. Such a manner of operation maintains transmission continuity even when switching between channels is required.

Referring to room B, RBCC 120 supports the Wi-Fi protocol and is connected wirelessly to a Lap-Top 121 and through a coax cable 125 to Internet Protocol TV (IPTV) 122. The RBCC 120 is connected to both coax socket 123 and power socket 124, and therefore it can communicate with other RBCCs over the coax line and/or the power-line respectively.

Another scenario is illustrated with respect to room C. The RBCC 131 is connected to a Personal Computer (PC) 132 and to a phone device 133. The RBCC 131 is connected in parallel to both phone socket 135 and to power-line socket 134. However, the power-line socket 134 in room C belongs to a different phase than the power-line socket 124 of room B. In addition, there is no phone socket in room B, and therefore there is no common wiring that directly connects rooms C and B. In this case, the communication between PC 132 in room C and the Lap Top computer 121 in room B is performed through the RBCC 105 of room A. Then, RBCC 105 of room A transfers the data which received from room C to room B (RBCC 120) through either the respective power or the coax lines which connect between said two rooms. Therefore, data can be transferred between two rooms event when there is no direct lines connecting between them. Furthermore, data may transfer through power-lines even when there is no electricity in the line.

RBCC may comprise build-in QoS application which supports smooth and leg-free streaming. The RBCC is also adapted to prioritize the data transferred according to user settings and logical definitions. The system utilizes the unused frequency spectrum, namely, 5-30 MHz.

The system provides multi-level QoS besides high bandwidth. Lighting-up the dark unused frequency spectrum, namely, 5-30 MHz, prevents interrupting to applications in a LAN which are bandwidth consuming and delay sensitive. One may easily view IPTV over a power-line or coax and access the internet at the same time

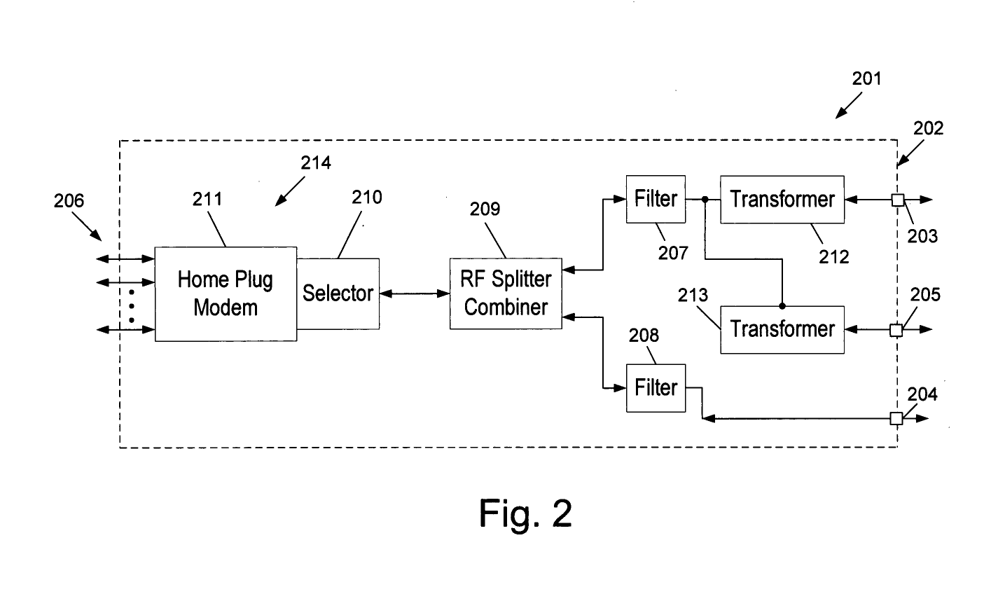

FIG. 2 schematically illustrates in block diagram form the general structure of the RBCC 201 according to an embodiment of the present invention. At side 202 the RBCC is connected to the house infrastructure.

In this embodiment the RBCC 201 has three ports that are adapted to connect to phone line 203, coax line 204, and power line 205. Second side 206 provides connection to one or more of Ethernet devices (IPTV, PC, streamer, laptop, phone, HDTV, modem and etc). Generally, this side comprises controllers for connecting to home devices through cat5, coax, power-line, Wi-Fi, or twisted pairs. The transmission of the RF signals by the RBCC 201 is broadband and full-duplex. Once signals are received from the house infrastructure via one of channels 203-205, they are filtered by filters 207-208, and then enter the RF splitter-combiner 209. The combined signal is then conveyed to selector 210 of the home plug unit 214.

Selector 210 senses the combined signal from which combines a same data which is received simultaneously (in case that indeed plurality of channels connect between the communicating RBCCs with respect to said signal), determines the best signal from among said combined signal (as said, each of the signals is received from a different channel), and conveys the selected signal to the home plug modem 211. Filters 207-208 are designed to allow all the plurality of RF signals to run simultaneously on the plurality of channels without collision or mutual interferences. The transformers 212-213 are responsible for insulation and impedance matching with the respective channels wires for maximizing the power transfer and minimizing reflections from the Ethernet devices connected to the RBCCs.

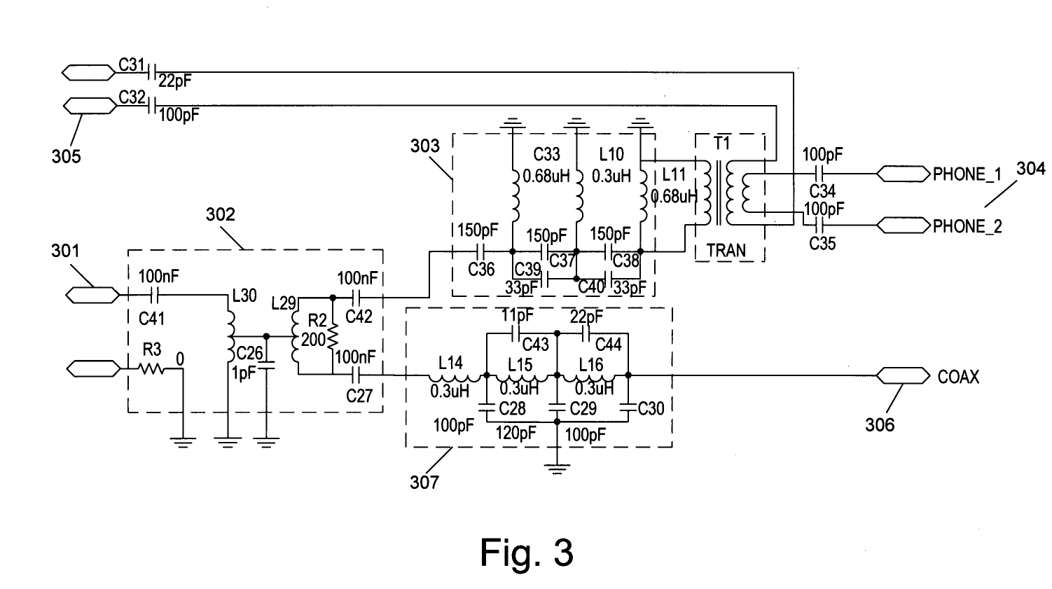

FIG. 3 illustrates a circuit diagram of one exemplary embodiment of a RBCC. In this embodiment the capacitance, resistance, and inductance values of the capacitors, resistors and coils have been selected to allow all channels (power-line, phone, and coax) transfer data in parallel (i.e., simultaneously).

The power-line connectors 301 connect between the home plug modem (not seen) and the RF splitter 302. RF splitter 302 in this embodiment is connected to a High Pass Filter (HPF) 303 for preventing interferences from the home plug modem (not shown) to the phone channel 304, and from the power-line 305 to the coax line 306. The RF splitter 302 is also connected to a Low Pass Filter (LPF) 307 for preventing interferences from the power-line 305 to the coax line 306.

The RBCC operates at low frequency band, namely, 5-30 MHz. The upstream frequency (i.e., from an Ethernet device to the RBCC), and the downstream frequency (i.e., from the RBCC to the Ethernet device) operates at the same 5-30 MHz band. The system is capable of supporting up to 256 end-users and supply broadband access to the Internet. In this embodiment the system supports 16 RBCC devices. The circuit of FIG. 3 provides filters that support a dynamic range of 90 db. This dynamic range is considered to be 10 db higher than the range of similar prior art systems (a significant improvement in the logarithmic scale).

As demonstrated, the RBCC of the present invention provides a reliable broadband communication over different types of existing cables in a house. The communication between two RBCCs is performed simultaneously on plurality of channels, when available. A selector at the receiving RBCC senses the received signals over the plurality of channels, and automatically selects the best quality signal. The amplitudes of all the signals received are continuously compared and the highest amplitude signal is considered as the best quality signal, and the corresponding channel is selected. Said best quality signal is then processed, and the others are ignored. Therefore, the invention enables operation also when one of the channels fails, as another one is selected. In such a manner, a continuity of operation is assured. In another embodiment, the determination of the best channel may be made periodically.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A Residential Broadband Cable Communicator for communicating over two or more types of cables within a house, each type of cables defines a channel, comprising:
a. a first port connected to a home Ethernet device;
b. plurality of second ports each of said second ports being connected respectively to one of said channels;
c. a HomePlug modem for receiving data from said Ethernet device through said first port, and transmitting the same simultaneously through two or more of said second ports over two or more of said channels respectively to another Residential Broadband Cable Communicator, and for receiving a selected best quality data signal from a selector, and conveying the same to said Ethernet device;
d. a selector for:
i. receiving a combined signal, said combined signal combines two or more data signals that are received from two or more of said channels respectively through said second ports;
ii. checking said combined signal, determining a best quality data signal from said combined signal, selecting said best quality data signal, and conveying the same to said HomePlug modem.

2. System according to claim 1, wherein the best quality signal which is selected is the one having a highest amplitude.

3. A Communicator according to claim 1, further comprising a splitter-combiner member for splitting data received from said HomePlug modem to said two or more channels, and for combining two or more data signals received from said two or more channels thereby to form said combined signal.

4. A Communicator according to claim 1, further comprising a set of filters for preventing interferences between channels, and for enabling all signals to run simultaneously on said two or more channels without collisions.

5. A Communicator according to claim 1, wherein the selector operates upon each signal received, and wherein the channel selection by the selector remains the same between any two selection steps.

6. Communicator according to claim 1, further comprising transformers, for providing channels insulation and impedance matching.

7. A Communicator according to claim 1, wherein said two or more types of cables are selected from the group comprising power-line cables, coaxial cables, and phone-line cables.

8. A Communicator according to claim 1, wherein said Ethernet device is selected from the group of, ISP modem. Lap-top computer, PC, modem, IPTV, HDTV, and telephone.

9. A Communicator according to claim 1, wherein said selector selects a data signal from said combined signal by selecting one carrier from among plurality of carriers employing advanced OFDM on said combined signal.

10. A Communicator according to claim 1, wherein said selector performs the best quality signal selection while keeping the transmission continuous.

11. A Communicator according to claim 4, wherein said set of filters comprises a first High Pass Filter (HPF) for preventing interferences between said HomePlug modem to a phone channel, and between said power-line channel and the coax channel, and a second Low Pass Filter (LPF) for preventing interferences between said power-line channel and said coax channel.

12. A Communicator according to claim 1, wherein a data signal may transfer over a power-line channel even in the absence of power in the power-line.

13. A Communicator according to claim 1, wherein the data transmission is performed at low frequency, namely, 5-30 MHz.
